(19) United States
(12) Patent Application Publication
(10) Pub. No.: US 2004/0191544 A1
(43) Pub. Date: Sep. 30, 2004

(54) Thermal barrier coating system

(76) Inventors: Ulrich Bast, Muenchen (DE); Peter Greil, Weisendorf (DE); Frank Mueller, Lauf (DE)

Correspondence Address: HARNESS, DICKEY & PIERCE, P.L.C., P.O.BOX 8910, RESTON, VA, 20195, US

(21) Appl. No.: 10/450,246

(22) PCT Filed: Mar. 31, 2003
(86) PCT No.: PCT/EP03/03358

(51) Int. Cl. B32B 15/04

(52) U.S. Cl. 428/469; 416/241 R; 428/633; 428/702; 427/446

(57) ABSTRACT

Thermal barrier coating systems according to the prior art are exposed to mechanical loads, and in particular ceramic layers tend to form cracks or to flake off on account of their brittleness. A thermal barrier coating system (19) according to the invention includes a second phase (34), which mechanically reinforces the matrix (31) of the layer (25, 28).

This application is the national phase under 35 U.S.C. § 371 of PCT International Application No. PCT/EP03/03358 which has an International filing date of Mar. 31, 2003, which designated the United States of America and which claims priority on European Patent Application number EP 02008046.1 filed Apr. 10, 2002, the entire contents of which are hereby incorporated herein by reference.

### FIELD OF THE INVENTION

The invention generally relates to a thermal barrier coating system which includes a substrate and layers applied thereto, and generally relates to processes for producing such a system.

### BACKGROUND OF THE INVENTION

EP 1 029 101 B1 has disclosed a thermal barrier coating in which the ceramic outer layer has the material composition La—Al—Gd—O or Sr—Ca—Zr—O.

U.S. Pat. No. 5,545,484 includes a layer system in which the substrate is mechanically reinforced by fibers.

The thermal barrier coatings are substantially functional layers and are intended to protect the substrate, for example from excessive heat. The substrate has a sufficiently high mechanical strength. The thermal barrier coatings are likewise exposed to thermal stresses or mechanical stresses and may fail as a result of flaking, because cracks are formed.

### SUMMARY OF THE INVENTION

Therefore, it is an object of an embodiment of the invention to provide a thermal barrier coating system and processes for its production, in which the layers are better able to withstand thermal and mechanical stresses.

An object may be achieved by a thermal barrier coating system. In this system, a second phase is introduced into the at least one layer, improving the mechanical properties of the layer. Further advantageous improvements to the thermal barrier coating system improve the mechanical strength (bending strength, compressive strength, etc.) and fracture toughness (K₁^{c}).

The second phase may be present in the form of fibers or particles. Suitable fibers are conventional carbon fibers or fibers of another material or whiskers.

The particles which form the second phase may include the same elements as the matrix material of the layer or alternatively may be selected from a different material system.

If the particles are elongate, i.e. have a high length to cross-sectional area ratio (high aspect ratio), the layer or the matrix material of the layer is advantageously reinforced by crack diversion and/or crack branching.

The layer which is to be reinforced which is selected may be a ceramic or metallic layer of the layers which have been applied to the substrate. In particular, this layer is the thermal barrier coating.

An object of producing a thermal barrier coating system which is reinforced by a second phase may be achieved by the processes.

The matrix material of the layer is applied by known coating processes, such as plasma spraying, CVD (chemical vapor deposition) or PVD (physical vapor deposition), the second phase being introduced into the matrix material of the layer via a separate source.

### BRIEF DESCRIPTION OF THE DRAWINGS

Exemplary embodiments are shown in the figures which follow, in which:

FIG. 1 shows a turbine blade or vane,

FIG. 2 shows a thermal barrier coating system,

FIG. 3 diagrammatically depicts the microstructure of a layer of the thermal barrier coating system according to an embodiment of the invention, and

FIG. 4 diagrammatically depicts a coating device allowing the processes according to an embodiment of the invention to be carried out, and

FIGS. 5, 6 show further exemplary embodiments of the thermal barrier coating according to an embodiment of the invention.

Identical reference symbols have the same meaning throughout the various figures.

### DETAILED DESCRIPTION OF THE PREFERRED EMBODIMENTS

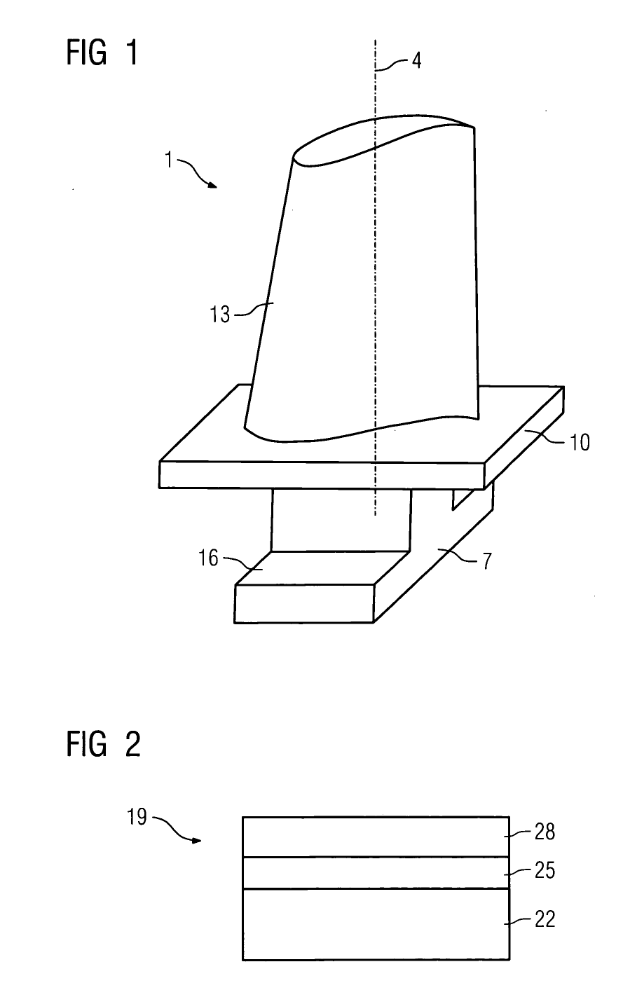

FIG. 1 shows a perspective view of a rotor blade which extends along a longitudinal axis 4. In succession along the longitudinal axis 4, the rotor blade 1 has a securing region 7, an adjoining blade platform 10 and a main blade region 13.

A blade root 16, which is used to secure the rotor blade 1 to a shaft (not shown) of a turbomachine (likewise not shown), is formed in the securing region 7. The blade root 16 is designed, for example, as a hammerhead. Other configurations are possible.

In conventional rotor blades, solid metallic materials are used in all the regions 7, 10, 13 and 16. The rotor blade may in this case be produced by a casting process, by a forging process, by a milling process or by combinations thereof.

Particularly in the main blade region 13, which is exposed to relatively high temperatures, for example from a gas turbine, at least one layer, in particular an oxidation/corrosion-resistant layer and thermal barrier coating, is applied, forming part of a thermal barrier coating system.

FIG. 2 shows a thermal barrier coating system 19 according to AN embodiment of the invention of this type. The thermal barrier coating system 19 has a substrate 22, for example a nickel-based or cobalt-based superalloy, to which, by way of example, at least one intermediate layer 25 is applied.

The intermediate layer 25 may include a plurality of layers which serve, for example, as a diffusion barrier, as a bonding layer (MCrAlY, M═Fe, Co, Ni), a corrosion-resistant layer or as an anchoring layer. By way of example, a ceramic thermal barrier coating 28 is applied to the substrate 22 or to the at least one intermediate layer 25. The at least one intermediate layer 25 and the thermal barrier coating 28 are exposed to mechanical loads.

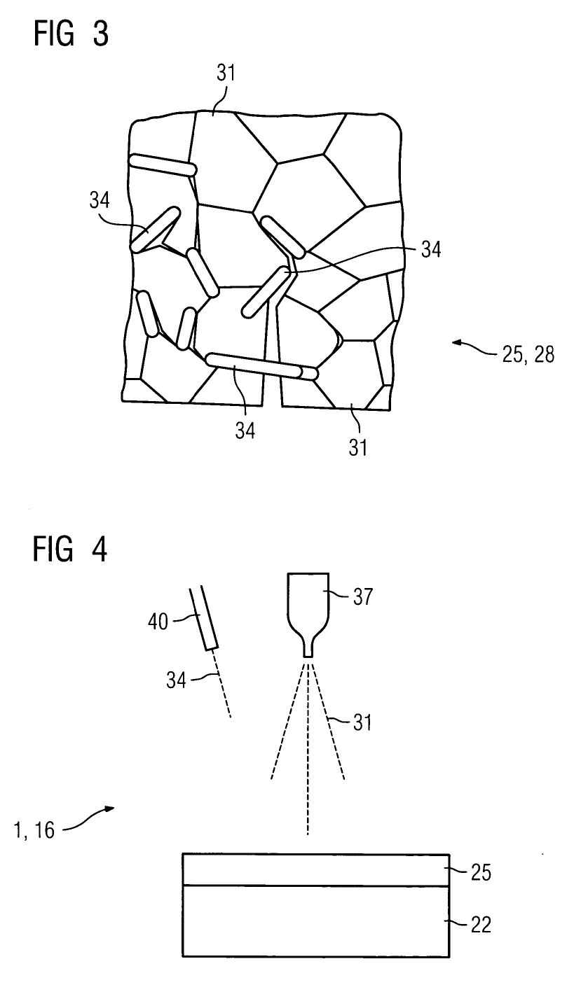

FIG. 3 diagrammatically depicts a microstructure of the intermediate layer 25 or of the thermal barrier coating 28. The layer 25, 28 according to an embodiment of the invention includes a matrix 31 and a second phase 34. The matrix 31 includes grains which may have various forms (morphologies). If the matrix 31 is produced, for example, by plasma spraying, the grains of the matrix material 31 are in platelet form. During the plasma spraying, the second phase 34 may, for example, be mixed with the matrix material 31 and applied jointly through a torch nozzle (FIG. 4).

The second phase 34 may be another phase of the matrix material 31, but may also be a fiber or a whisker. The second phase 34 has an object of improving the mechanical strength of the matrix 31. This can be ensured by fiber reinforcement or particle reinforcement using the known reinforcement mechanisms. Particularly if the second phase 34 is elongate in form, the mechanical strength of the matrix 31 is particularly improved.

The materials which are disclosed in EP 1 029 101 B1, i.e. the systems La₁₋ₓ Gdₓ AlO₃ or Ca₁₋ₓ Srₓ ZrO2₃, may be suitable as material 31 for the thermal barrier coating 28. EP 1 029 101 B1, the entire contents of which are incorporated herein by reference, is in particular to form part of the disclosure of the present application. The elements Gd and La may be replaced by other lanthanides.

In particular, the second phase 34 having the composition LaAl₁₁O₁₈ (βaluminate) is used as second phase 34 for reinforcing the matrix 31 for the matrix material 31 Gd—La—Al—O.

The layer 25, 28 can be produced by various coating processes, such as for example plasma spraying, CVD processes or PVD processes. In the case of plasma spraying, the second phase 34 can be mixed with the matrix material 31 and applied to the substrate 22 or the intermediate layer 25 through the torch nozzle.

However, for certain second phases 34, the situation may arise wherein the second phase is not phase-stable at the high temperatures of the plasma spraying. With the CVD or PVD processes, it may also be the case that only one material composition, namely that of the matrix 31, can be applied using this process. In this case, the second phase is introduced into the layer 25, 28 via a separate auxiliary nozzle 40 (FIG. 4).

FIG. 4 diagrammatically depicts a coating device which allows a second phase and a matrix material 31 to be applied. By way of a main nozzle 37, which is, for example, a torch nozzle of a plasma coating installation, or a substrate 37 of a PVD installation, the matrix material 31 is applied to the substrate 22 or the at least one intermediate layer 25.

The second phase 34 is mixed into the particle stream of the matrix material 31 by way of a separate source, for example an auxiliary nozzle 40. Thus, a matrix 31 with a second phase which amounts to less than 50% by volume is formed.

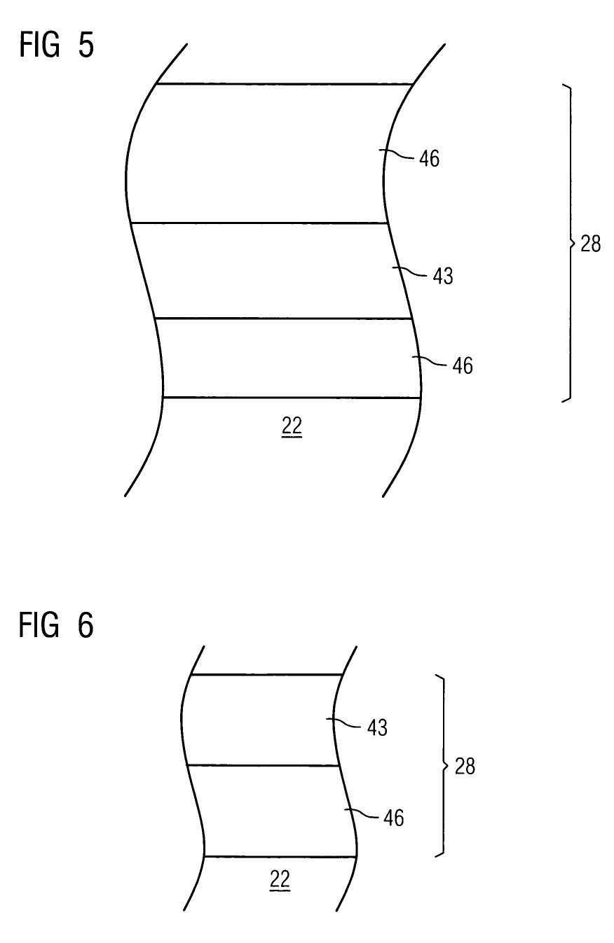

FIG. 5 shows a coating of a thermal barrier coating system according to the invention. The coating 28 is in at least two-layer form, including two layers 46 which are not reinforced and one layer 43 which is reinforced by a second phase. The first layer 46 rests, for example, on the substrate 22 or the layer 25. This is followed by the layer 43 and, as outer layer, the unreinforced layer 46.

Cracks cannot grow through the layer 43 or can only do so with difficulty, and this prevents the coating 28 from becoming detached from the substrate 22.

FIG. 6 shows a coating of a thermal barrier coating system according to the invention. The coating 28 is in two-layer form, including a layer 46 which is not reinforced and a layer 43 which is reinforced by a second phase. The first layer 43 rests, for example, on the substrate 22 or the layer 25. This is followed by the layer 43 as the outer layer, or vice versa.

Cracks cannot grow through the layer 43 or can only do so with difficulty, this prevents the coating 28 from becoming detached from the substrate 22.

List of reference symbols:

1 Turbine blade or vane

4 Longitudinal axis

7 Securing region

10 Blade platform

13 Main blade region

16 Blade root

19 Thermal barrier coating system

22 Substrate

25 Intermediate layer

28 Thermal barrier coating

31 Matrix

34 Second phases

37 Main nozzle

40 Auxiliary nozzle

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A thermal barrier coating system, comprising:
a substrates;, and
at least one layer applied thereto the substrate, characterized in that the presence of wherein a second phase is included (34) in a matrix material (31) of the at least one layer (25, 28) to improves a mechanical property of the at least one layer (25, 28) compared to a layer which consists only of the matrix material.

2. The thermal barrier coating system as claimed in claim 1, characterized in thatwherein the mechanical property is the mechanical strength.

3. The thermal barrier coating system as claimed in claim 1, characterized in thatwherein the mechanical property is the fracture toughness.

4. The thermal barrier coating system as claimed in claim 1, characterized in thatwherein the second phase (34) is a fiber.

5. The thermal barrier coating system as claimed in claim 1, characterized in that wherein the second phase (34) is formed by particles, so that the at least one layer (25, 28) is particle-reinforced.

6. The thermal barrier coating system as claimed in claim 5, characterized in thatwherein the particles (34) are elongate in form.

7. The thermal barrier coating system as claimed in claim 1, characterized in that wherein the at least one layer (25, 28) is a ceramic layer.

8. The thermal barrier coating system as claimed in claim 1 or 7, characterized in thatwherein the at least one layer (25, 28) is a thermal barrier coating (28).

9. The thermal barrier coating system as claimed in claim 1 or 7, characterized in thatwherein the matrix material (31) of the at least one layer includes (28) has a composition belonging to the La—Al—O system.

10. The thermal barrier coating system as claimed in claim 1 of 7, characterized in that wherein the matrix material (31) of the at least one layer includes(28) has a composition belonging to the Gd—La—Al—O system.

11. The thermal barrier coating system as claimed in claim 1 or 7, characterized in thatwherein the matrix material (31) of the at least one layer (28) is formed from the Sr—Ca—Zr—O system.

12. The thermal barrier coating system as claimed in claim 1, characterized in thatwherein the second phase includes(34) has the composition LaAl₁₁O₁₈.

13. The thermal barrier coating system as claimed in claim 1, characterized in thatwherein the at least one layer (25, 28) is a metallic layer, in paricular a MCrAlY layer (25).

14. The thermal barrier coating system as claimed in claim 9, 10 or 12, wherein characterized in that the lanthanum in at least one of the matrix material and ora material of the second phase is replaced by other lanthanides.

15. The thermal barrier coating system as claimed in claim 1, characterized in thatwherein the thermal barrier coating system (16) forms at least one of a turbine blade andor vane (1).

16. The thermal barrier coating system as claimed in claim 1, characterized in thatwherein the thermal barrier coating comprises at least two layers.

17. The thermal barrier coating system as claimed in claim 16, characterized in thatwherein an relatively outer layer part the at least two layers of the thermal barrier coating includes the second phase.

18. The thermal barrier coating system as claimed in claim 16, characterized in thatwherein a relatively an inner layer part of the at least two layers of the thermal barrier coating includes the second phase.

19. The thermal barrier coating system as claimed in claim 1, characterized in thatwherein the second phase is only locally present.

20. A process for producing a thermal barrier coating system, comprising:
applying in which thea matrix material (31) of at least one layer (25, 28) is applied to at least one of a substrate (22) orand a layer (25) by means of plasma spraying,; and
introducing athe material, of a second phase of the at least one layer,(34) being introduced into the matrix (31) via an auxiliary nozzle (40).

21. A process for producing a thermal barrier coating system, in whichcomprising:
applying athe matrix material (31)of at least one alayer (25, 28) is applied to at least one of a substrate and (22) or a layer (25) by way means of a PVD process,; and
introducing athe material, of a second phase of the at least one layer, (34) being introduced into the matrix (31) via an auxiliary nozzle (40).

22. A process for producing a thermal barrier coating system, in which comprising:
applying ate matrix material (31) of aat least one layer (25, 28) is applied to aat least one of a substrate (22) or and a layer (25) by waymeans of a CVD process,; and
introducing athe material, of a second phase of the at least one layer(34) being introduied, into the matrix (31) via an auxiliary nozzle(40).

23. The thermal barrier coating system as claimed in claim 1, wherein the second phase improves a mechanical property of the at least one layer as compared to a layer which consists only of the matrix material.

24. The thermal barrier coating system as claimed in claim 7, wherein the at least one layer is a thermal barrier coating.

25. The thermal barrier coating system as claimed in claim 7, wherein the matrix material of the at least one layer includes a composition belonging to the La—Al—O system.

26. The thermal barrier coating system as claimed in claim 7, wherein the matrix material of the at least one layer includes a composition belonging to the Gd—La—Al—O system.

27. The thermal barrier coating system as claimed in claim 7, wherein the matrix material of the at least one layer is formed from the Sr—Ca—Zr—O system.

28. The thermal barrier coating system as claimed in claim 1, wherein the at least one layer is an MCrAlY layer.

29. The thermal barrier coating system as claimed in claim 10, wherein lanthanum in at least one of the matrix material and a material of the second phase is replaced by other lanthanides.

30. The thermal barrier coating system as claimed in claim 12, wherein lanthanum in at least one of the matrix material and a material of the second phase is replaced by other lanthanides.

31. A turbine blade comprising the thermal barrier coating system as claimed in claim 1.

32. A turbine vane comprising the thermal barrier coating system as claimed in claim 1.
